(19) United States
(12) Patent Application Publication
(10) Pub. No.: US 2020/0224651 A1
(43) Pub. Date: Jul. 16, 2020

(54) LINEAR RACK DRIVE FOR SUBMERSIBLE ROD PUMP FOR OIL PRODUCTION

(71) Applicant: Aleksander KURKOV, Chistoe Yuzhnoe poselok (RU)

(72) Inventor: Aleksander KURKOV, Chistoe Yuzhnoe poselok (RU)

(21) Appl. No.: 16/735,784

(22) Filed: Jan. 7, 2020

(30) Foreign Application Priority Data
Jan. 10, 2019 (RU) RU2019100711/06

(51) Int. Cl. F04B 47/02; F04B 17/03; E21B 43/12

(52) U.S. Cl. CPC F04B 47/02; F04B 17/03; F16H 55/26; F05B 2260/4031; E21B 43/126

(57) ABSTRACT

Linear rack and pinion drive for submersible rod pump for oil production contains a gear rack of symmetric polygonal cross-section with a closed through-hole. The gear rack can have teeth on its single or several facets, with appropriate number of pinions and electric drive units. Availability of more than single drive units allows to mutually counterbalance the lateral forces from the pinions and decrease a material consumption. The teeth of the gear rack can be spur, helical, herringbone or arched. The gear rack implemented compound, all elements are fixedly interconnected by use of welding, gluing, riveting, screwing or made dismountable. Due to the compound gear rack design the manufacturability is improved. It allows to implement gear rack virtually of infinite length. Support bearing assembly eliminates the transmission of torque from the polished rod to the rack that eliminates the need for additional guideways for the rack.

This application is the United States national application of Russian Patent application No RU 2019100711/06 Filed Jan. 10, 2019, the entire disclosure of which is incorporated herein by reference.

### FIELD OF THE INVENTION

The invention relates to the field of petroleum engineering, and in particular to pumping systems for extracting formation fluid from wells, in particular, oil production using submersible rod pump equipment.

### BACKGROUND

In the technique of developing liquid minerals, in particular crude oil, the submersible rod pump equipment is widespread pumping system.

Common features of these equipment are as follows:
1) The operating device of the pumping system is a piston submersible pump located directly in the oil well.
2) Transmission consists of a rod column with a polished rod connected as its upper member. It connects the surface drive to the submersible pump and transmits reciprocating motion down to it.
3) Surface drive (electromechanical converter), converting electrical energy into mechanical energy of reciprocating motion.
4) The control system of the pumping unit.

An important factor that must be taken into account in order to optimize the submersible rod pump drive equipment performance is the extension of the submersible rod column, the length of which can be more than 300 m, and the pull force fluctuations in different phases of the pump operation can reach even more than 120 kN. Under these conditions, the pump rod column acts as a tension spring, which elongates during the up stroke, and shortens during the down stroke. The magnitude of such fluctuations of length can be more than 0.8 m and tends to increase when working in deeper wells. Thus, this value of parasitic fluctuations in the length of the rod column is subtracted from the total length of the stroke of the surface pump drive. To achieve an acceptable efficiency of surface pump drive, this necessitates the use of surface drive machine with a stroke significantly exceeding the above-described fluctuation in the length of the pump rod column.

Known “LINEAR ROD PUMP APPARATUS AND METHOD” [U.S. Pat. No. 8,152,492 B2]. The apparatus makes a reciprocating vertical movement of the rod column of the submersible rod pump.

The apparatus contains:

Linear mechanical drive, consisting of:
housing mounted on the wellhead flange;
a vertically located movable member connected with the rod column of the submersible pump, with which a controlled reciprocating vertical movement of the rod column of the submersible pump is performed;
a reversible motor connected through a gearbox to a vertically movable element.

The motor alternately rotates first in the forward direction at the first part of the pump stroke (piston stroke up), and then in the opposite direction when the second part of the pump stroke flows (piston stroke down);

The linear drive device includes a rack and pinion drive, consisting of a rack and pinion, adapted to operate in the vertical direction to reciprocate the rack along the axis of the pump stroke. The gear rack is engaged with the pinion, and this pinion is functionally connected to the rotating shaft of the electric motor. Thus, the rotation of the electric motor in the forward direction makes the movement of the rack vertically up along the axis of the pump stroke, and the movement of the rack vertically down is accompanied by rotation of the motor in the alternating directions. A gear rack is mechanically connected to a polished rod to transmit force.

The rack has at its upper end a unit with a clip for attaching the rod. In the rack there is a through longitudinally directed hole along the axis of the pump stroke. The rod has the ability to move inside the rack in the hole. The fixing clip provides support and transfers force to the upper end of the polished rod from the drive rack.

The drive rack having a U-shaped cross section forming a longitudinally directed open channel located around the axis of the pump stroke, and there are teeth for engaging with the corresponding teeth of the pinion.

The linear drive device also has one or more guideways roller bearings. They are placed longitudinally, to provide engagement of the teeth of the rack with the pinion;

The linear drive device of a submersible rod pump has a pair of guide bearings placed on the sides of the legs of the rack, opposite each other, for forcibly keeping the rack in a position that engages the teeth of the rack with the pinion.

This technical solution can provide a flexible optimal work cycle with the ability to separately control the speed of a polished rod at any stage, including the possibility of introducing a waiting stage between the stages of “upward” and “downward”. In addition, on use such devices there is no need to use massive foundations at the wellhead. The device has a significantly lower metal consumption (total weight) and is completely attached directly to the wellhead flange without the need for a foundation. The disadvantage of this patent is that in this design the guideways are formed by four flat surfaces, the manufacturing of which with a desired accuracy is a complex and time-consuming task both in the housing and on the rack itself, and requiring clearance adjustment devices. Also, a rather difficult task is to manufacture a gear rack of large length with a through channel. The need to provide a polished rod stroke of at least 2000 mm causes the need for a long rack (more than 2500 mm).

The next attempt to improve the drive device of submersible rod pumps was a device according to the utility model “Linear rack drive submersible rod pump for oil production” RU 168390 U1. The device is a linear rack and pinion drive for submersible rod pumps, in which, in contrast to the one described in US patent U.S. Pat. No. 8,152,492 B2, a circular shaped gear rack is used instead of a U-shaped rack. The rack can be made of a solid metal of round shape by carrying out turning, milling and drilling operations. This design is more simple to manufacture, since the guides are formed by one cylindrical surface, this form is easier to implement in practice.

However, this device also has some drawbacks:
the technological complexity of manufacturing a gear rack of large length with a through channel,
the need to use relatively expensive cylindrical-bevel gearbox to locate the center of gravity of the gearbox as close to the axis of the rack as possible.
the occurrence of significant reactive lateral forces from the interaction of the pinion with the gear rack and the need for the perception of these forces by the guideways, which additionally leads to an increase in the metal consumption of the device.

This technical solution is the closest in essence and the achieved effect to the proposed device.

The purpose of the invention is to reduce the metal consumption and easing the manufacturing of rack unit.

### SUMMARY OF THE INVENTION

This goal is achieved due to the gear rack is made compound and has a cross-section in the shape of a symmetric polygon, and the teeth of the gear rack are implemented symmetrically relative to the center of the polygon, on two to six sides of this polygon. The polished rod is connected to the rack, mainly in its upper part.

Also in the rack there can be a closed channel through its length, the axis of which coincides with the axis of the polished rod, the channel is located in the center of the rack and is designed to accommodate a polished rod in it. It is advisable to connect the rod to the rack through a bearing support, allowing the rod to rotate relative to the rack and rise relative to it. This solution protects against torque transmission from the polished rod to the rack, which eliminates the need for additional guideways. The ability of the rod to be raised relative to the rack protects it from damage in the event of a sticking rod or pump.

The unit for converting electrical energy into rotational movement of the drive gears (electric drive unit), consisting of an electric motor, gearbox and pinion, is made divided into several identical parts located symmetrically around the axis of the rack.

The device may include an electric or mechanical rod rotator designed for forced rotation of the rods. The rack can be made compound of parts that are fixedly connected to each other by welding or demountable, mainly by screws.

The presence of teeth on the rack on more than one side (mainly on the two), with the appropriate number of electric drive units, reduces the metal consumption of the installation. Several components provides this effect:

1. The balance of the reaction forces from the pinions of the rack and pinion gear allows to reduce the cross section of the rack and pinion gear housing and of the gear rack itself, as the bending forces are reduced.

2. The compound gear rack design allows initially at choosing a cross-section, to take only as much material as necessary to provide the desired strength of the rack, forming a through channel of a multifaceted shape with an optimal wall thickness, and not be limited to existing workpieces (eg round shape), subsequently removing excess material by drilling or by milling, without achieving the goal. This gives a 10-20% reduction in metal consumption.

Reducing the total cost of a gear rack is due to the fact that such expensive operations as deep drilling, milling planes and cutting teeth on long workpieces and heat treatment of long parts are eliminated.

The compound gear rack design allows to implement it virtually of infinite length.

Using of helical, herringbone or arched teeth can increase the load-carrying capacity and smoothness of the rack and pinion gear operation.

The essence of the invention is illustrated by drawings.

### BRIEF DESCRIPTION OF THE DRAWINGS

FIG. 1 shows a general view of a linear rack and pinion drive for a submersible rod pump in a twin-motor version.

FIG. 2 shows its section in a vertical secant plane.

FIG. 3 shows a section in a horizontal secant plane.

FIG. 4 shows in cross section by horizontal secant plane embodiment of a rack and pinion drive for a submersible rod pump with three electric drive units.

FIG. 5 shows a front view of a rack and pinion drive for a submersible rod pump with three electric drive units.

FIGS. 6 and 7 shows the embodiment of a rack and pinion drive for a submersible rod pump with four electric drive units.

FIG. 8a, 8b in two views shows an embodiment of a rectangular shaped rack with two gear surfaces.

FIG. 9 shows an embodiment of a rack (cross section view) of a hexagonal shape with three toothed surfaces.

FIG. 10a, 10b in two views shows an embodiment of a rack of rectangular shape with four gear surfaces.

FIG. 11a, 11b in two views shows an embodiment of a rack, consisting of short sections.

FIG. 12a, 12b in two views shows an embodiment of a rectangular rack with two gear surfaces and a base 38 in the form of a square tubing is shown.

In FIG. 13a, 13b in two views shows an embodiment of a rectangular rack with one gear surface and a base 38 in the form of a square tubing.

FIG. 14a, 14b in two views shows an embodiment of a rack with spur teeth.

FIG. 15a, 15b in two views shows an embodiment of a rack with helical teeth.

FIG. 16a, 16b in two views shows an embodiment of a rack with arched teeth.

FIG. 17a, 17b in two views shows an embodiment of a rack with herringbone teeth.

The following notation is used in the drawings:

3—bearing, 4—housing, 5—polished rod, 6—first electric motor, 7—first gearbox, 8—rack, 9—first drive gear, 10—bearing, 11—second electric motor, 12—a second gearbox, 13—a second drive gear, 14—an oil bath, 15—a damper, 16—a double rack and pinion drive housing, 17—a third electric motor, 18—a third gearbox, 19—a fourth electric motor, 20—a fourth gearbox, 23—gear-three-gear gear rack, 24—lower double rack and pinion drive housing, 25—the third drive gear, 26—toothed strip, 28—the connecting strip, 29—the weld, 31,33—adjacent sections of the rack, 32—the junction line between the sections of the rack, 34—spur rack, 35—helical gear rack, 36—a gear rack with arched teeth, 37—a gear rack with herringbone teeth 38—rack base.

### DETAILED DESCRIPTION OF THE INVENTION

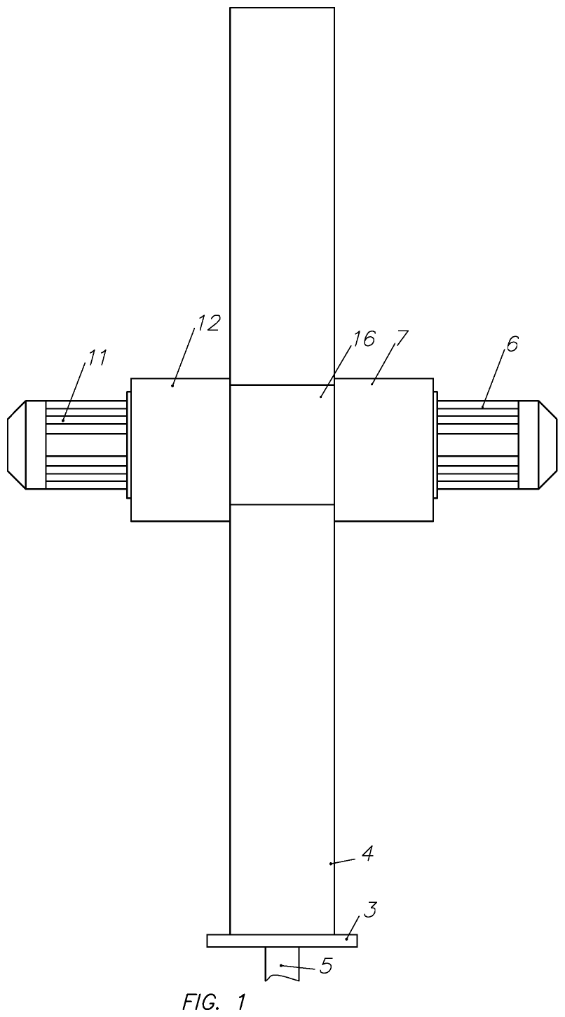

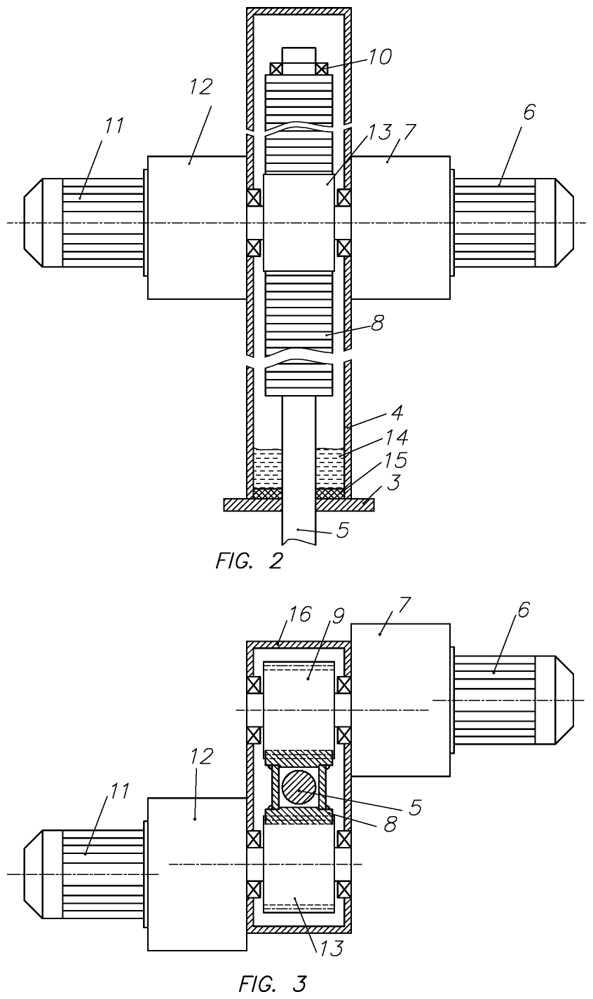

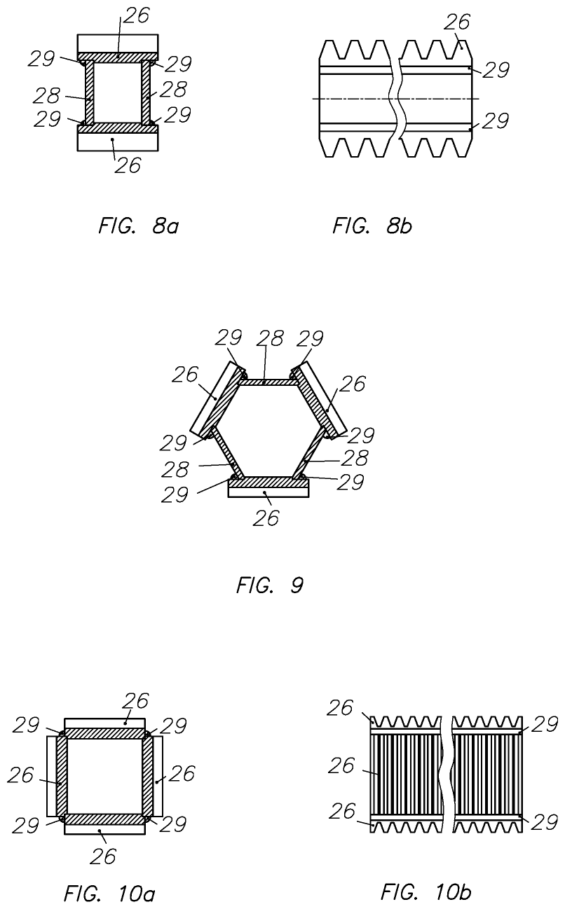

FIG. 1-3 shows the linear rack-and-pinion drive of a submersible rod pump in a twin-motor version. In FIG. 1, FIG. 2 and FIG. 3 shows the structure of a linear rack and pinion drive in the embodiment with two electric drive units and utilizing of the gear rack shown in FIG. 8a, 8b.

At a wellhead, the support 3 is fixed, to which the housing 4 is fixedly attached (welded), in the middle part along the height of which is located the gear rack double gear housing 16. There are the gear housings 7 and 12 connected to the housing 16 by welding or bolts symmetrically relative to the vertical axis of the gear rack 8.

Electric motors 6 and 11 are connected to the gearboxes, 7 and 12, respectively, and drives them into rotation.

On the output shafts of these gearboxes 7 and 12, the first 9 and second 13 pinions are fixed, with their teeth are engaged with the corresponding gear surfaces of the rack 8. Inside the rack 8 there is a through vertical closed channel (hole) into which the polished rod 5 is passed, by the upper end resting on the rack 8 through the bearing support 10. The lower end of the rod 5 goes into the well and is coupled to the rods column for drive the submersible pump (not shown). In the lower part of the housing 4 of the drive is an oil bath 14 for lubricating the rod 5 and rack and pinion drive, consisting of gears 9 and 13 and rack 8. Also in the lower part of the housing there is a damper 15, designed to limit the movement of the gear rack 8 down to prevent it from going beyond limits of the operating range when the drive malfunctions or when it is stopped for maintenance.

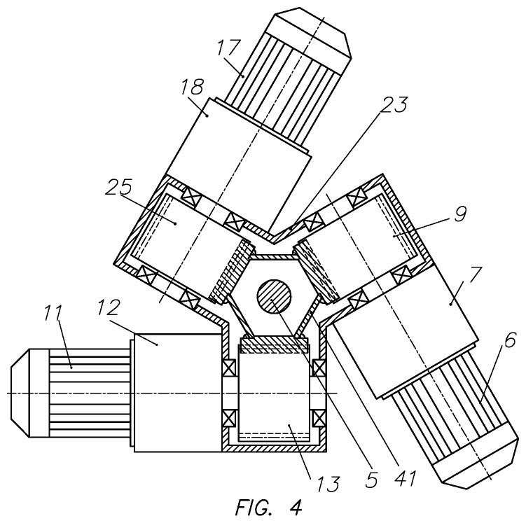

All other embodiments of the linear rack drive for a submersible rod pump shown in FIGS. 4-7 are arranged similarly and differ only in the number and arrangement of electric drive units. Differences are clearly visible in the named drawings.

FIG. 4 shows in cross section by a horizontal secant plane an embodiment of a rack and pinion drive with three electric drive units, consisting, respectively, of electric motors 6, 11, 17, gears 7, 12, 18, gears 9, 13, 25 and using a gear rack, shown in FIG. 9.

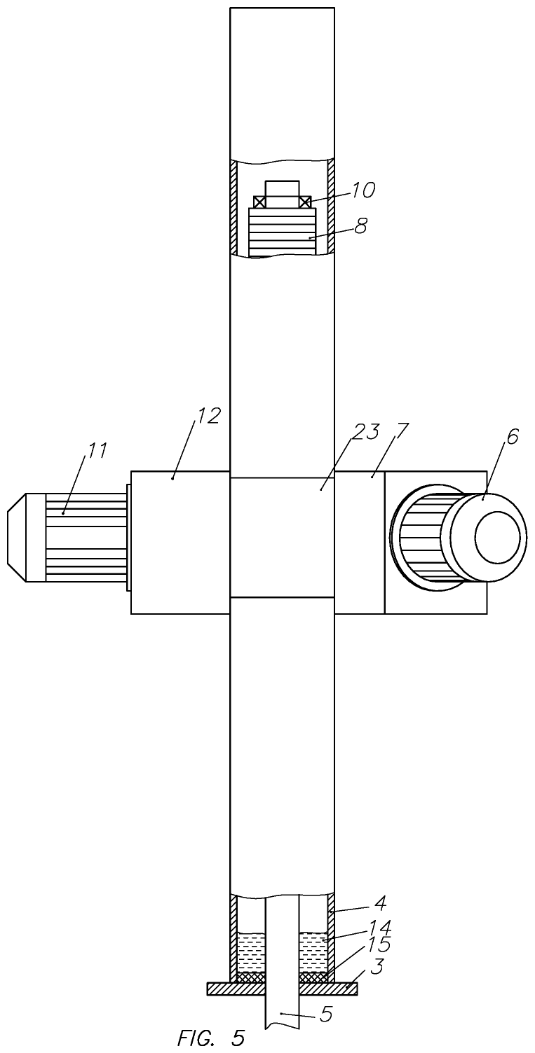

FIG. 5 is a front view of a rack and pinion drive with three electric drive units.

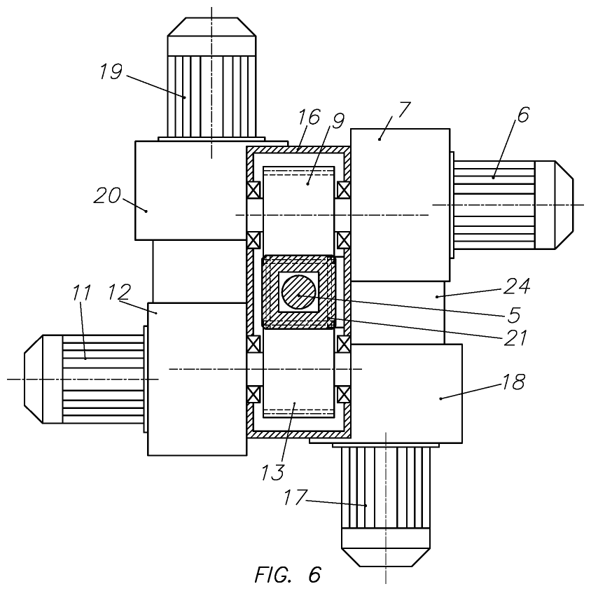

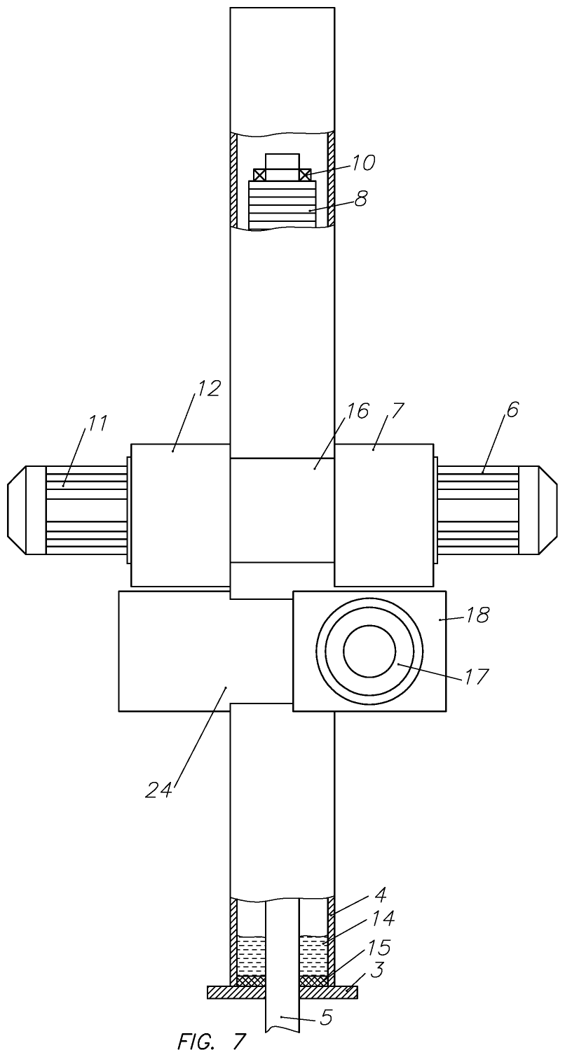

FIG. 6 and FIG. 7 shows a rack and pinion drive in an embodiment with four electric drive units consisting, respectively, of electric motors 6, 11, 17, 19, pinions 7, 12, 18, 20, gears 9, 13, 25 and one more (not shown in figures) and using the gear rack shown in FIG. 10a, 10b. Lower double rack and pinion drive housing 24 is placed under the double rack and pinion drive housing 16. Electric drive units are placed in two tiers along the height of the gear rack.

FIG. 8 to FIG. 13 shows various embodiments of gear racks.

FIG. 8a, 8b in two views shows an embodiment of a rectangular shaped gear rack with two toothed surfaces. The rack consists of elements in the strips shape, while teeth are formed on the toothed strips 26, and the strips 28 have no teeth and are used to connect into a single unit—a gear rack. When assembling the strips, they are motionlessly connected to each other mainly by a weld seam 29, but other connection methods can be applied, such as: soldering, glue, bolting, etc.

FIG. 9 shows an embodiment of a gear rack (cross section view) of a hexagonal shape with three toothed surfaces. The rack consists of elements in the form of strips, while teeth are formed on the toothed strips 26, and the strips 28 have no teeth and are used to connect into a single unit—a gear rack. When assembling the strip, they are fixedly attached to each other mainly by a weld 29, but other connection methods can also be applied, such as soldering, gluing, screwing, etc.

FIG. 10a, 10b in two views shows an embodiment of a gear rack of rectangular shape with four toothed surfaces. The gear rack consists of elements in the form of strips, while teeth are formed on the toothed strips 26. On assembling the strip, they are fixedly attached to each other mainly by a weld 29, but other connection methods can also be applied, such as soldering, gluing, screwing, etc.

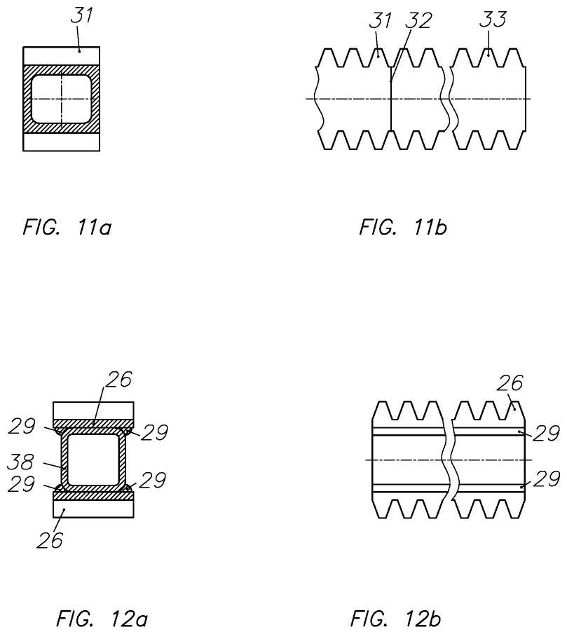

FIG. 11a, 11b in two views shows an embodiment of a gear rack, consisting of short elements. The elements 31, 33 can be made, for example, by casting. The length of the elements is chosen optimal so to minimize the number of joints 32 when assembling the rails and sufficient manufacturability of the elements. On assembling the elements are interconnected mainly by welding.

FIG. 12a, 12b in two views shows an embodiment of a rectangular shaped gear rack with two toothed surfaces and a base 38 of a square tubing. The rack consists of elements in the form of strips 26, on which teeth are formed, and the base 38 of a square tubing. On assembling, the strips are fixedly connected to the base 38 mainly by weld 29, but other connection methods can be applied, such as soldering, gluing, screwing etc.

FIG. 13a, 13b in two views shows an embodiment of a rectangular gear rack with one toothed surface and a base of a square tubing. The rack consists of a strip 26 on which the teeth are formed and the base 38 of a square tubing. When assembling, the strip is fixedly connected with a base 38 mainly by weld 29, but other connection methods can be applied, such as soldering, gluing, screwing etc.

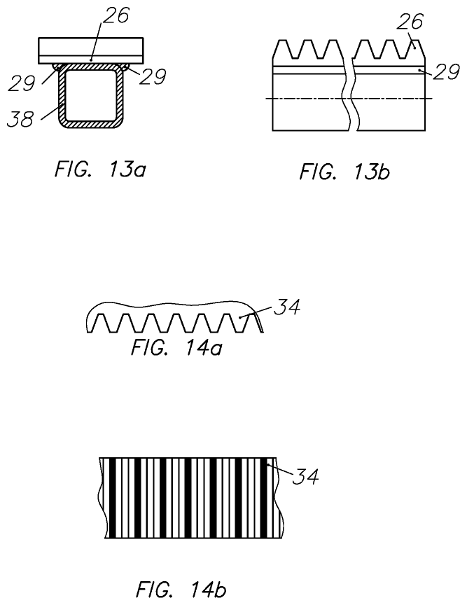

FIGS. 14 to 17 shows various options for the teeth of the racks.

FIG. 14a, 14b in two views shows an embodiment of the spur rack 34.

FIG. 15a, 15b in two views shows an embodiment helical rack 35.

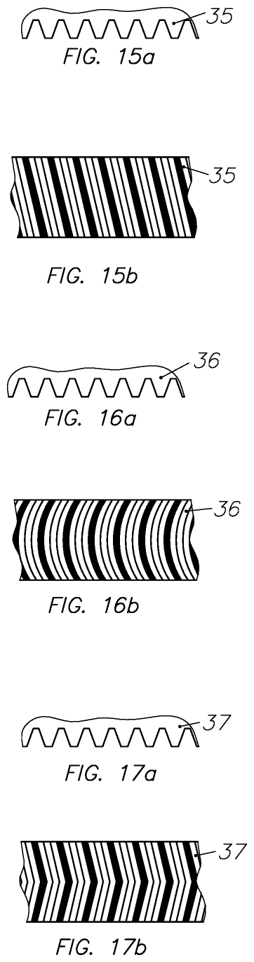

FIG. 16a, 16b in two views shows an embodiment of the rack 36 with arched teeth.

FIG. 17a, 17b in two views shows an embodiment rack 37 with herringbone teeth.

The device operates as follows.

The linear rack drive for a submersible rod pump in the embodiment with two electric drive units (FIGS. 1-3) is installed directly on the wellhead flange and is fastened with the support 3. Support 3 is designed to mount the housing 4 on the wellhead flange and serves as the bottom oil bath 14 for lubricating the gear rack 8 and the pinions 9, 13. On the housing 4 there is a double-gear housing of rack and pinion gear 16. On the double-gear housing of rack and pinion gear mounted: the first gearbox 7 with an electric motor 6, rotating the pinion 9, as well as the second gearbox 12 with the second electric motor 11, driving the pinion 13. The electric motors 6 and 11 connected to the rack mechanism through gears 7 and 12 and gears, respectively, 9 and 13, rotating alternately in in different directions, move the rack 8 up and down to drive the polished rod 5. During each stroke, the rack is lubricated by immersion in oil poured into the oil bath 14 formed in the housing 4. The polished rod 5 passes through a channel inside the gear rack 8 supported top bearing bracket 10 above the center of the wellhead polished rod unilaterally fixed along an axis and is able to rise with respect to the rack rod in the case of sticking or pump in the well.

Damper 15 is designed to support the gear rack in the lower position during stops and repairs, and to prevent it from going beyond the operating range in the event of equipment failure.

All other embodiments of the linear rack and pinion drive for a submersible rod pump shown in FIGS. 4-7 are arranged and operate similarly and differ only in the number and arrangement of electric drive mechanisms. Differences are clearly visible in the named drawings.

Calculation of the gear transmission for a force of 120 KN and a stroke length of 3500 mm in two versions—with two and one electric drive mechanisms, both racks of the compound structure according to FIGS. 12 and 13, respectively, shows the following main property:

| | two electric | | one electric | |
|---|---|---|---|---|
| property | drive units | | drive unit | |
| rack and pinion gear teeth module, mm | 8 | | 12 | |
| the number of pinion teeth, pcs | 17 | | 17 | |
| the outer diameter of pinion, mm | 152 | | 228 | |
| pinion width, mm | 94 | | 140 | |
| pinion blank weight, kg (in brackets - | 13.5 | (27) | 45 | (45) |
| set for the whole device) | | | | |
| pinion torque, N * m | 4200 | | 12600 | |
| the width of the teeth of the rack, mm | 88 | | 133 | |
| rack blank weight, kg | 251 | | 289 | |
| Gearbox weight, kg (in brackets - set | 335 | (670) | 760 | (760) |
| for the device) | | | | |

| | | |
|---|---|---|
| Summary blanks weight per | 948 | 1094 |
| transmission set (gears, gearbox, rack), | | |
| kg | | |

There can be seen a decrease in the metal consumption of the embodiment with two electric drive units by 15% relative to the embodiment with one electric drive unit.

It is also worth the lower machining time by about 15% of producing two toothed surfaces of the gear rack 8 and two pinions 9, 13 with an 8 mm module relative to one toothed surface of the gear rack and one pinion with a 12 mm module.

Electric drive units (consisting, respectively, of electric motors 6 and 11, gearboxes 7 and 12, pinions 9 and 13) are located symmetrically relative to the axis of the rack 8, which leads to the fact that the reaction forces on the gear rack are mutually balanced, which allows you to refuse partially or completely from the guides and support rollers. Also, the symmetrical arrangement of the electric drive units causes to the balancing of their gravity forces and reactive forces on the housing 4 of the linear rack drive for a submersible rod pump.

This allows the use of a drive gear with cylindrical gears instead of the more expensive cylindrical-bevel ones, with no care of the location of the center of gravity of the gear as close as possible to the rack axis.

Also, in the case of the required relatively small load-carrying capacity of a linear rack and pinion drive for a submersible rod pump, it can be implemented with one electric drive unit and a one-sided arrangement of the toothed surface on the gear rack, while the gear rack is made compound (FIG. 13a, 13b). This option is advisable, since in this case the positive effect of the use of a divided electric drive unit is leveled out by the complication of the design, but the implementation of a compound rack significantly reduces its cost.

Reducing the cost of the rack is due to the fact that such expensive operations as deep drilling, milling planes and cutting teeth on long workpieces and heat treatment of long parts are eliminated.

The use of helical, herringbone or arched teeth can increase the load-carrying capacity and smoothness of the rack and pinion gear.

A linear rack and pinion drive for a submersible rod pump with a load-carrying capacity of 12 tons with a stroke length of 3.5 m and two electric drive units was designed.

The verification calculation showed the possibility of reducing total weight of a linear rack and pinion drive for a submersible rod pump by 30% compared to a device with a one-way drive.

I claim:

1. A linear rack drive for a submersible rod pump for oil production, comprising
electric drive units,
a rack and pinion drive including a gear rack, a pinions mechanically connected to output members of respective electric drive units,
a polished rod connection unit, wherein
the gear rack is made compound and has a cross section as a symmetric polygonal shape, and the rack teeth are formed symmetrically with respect to the center of a polygon, and the gear rack gets simultaneously the driving force from at least two drive units.

2. The linear rack drive according to claim 1, wherein a toothed surface of the gear rack is made up of several parts having a length shorter than a length of the whole toothed surface of the gear rack, fixedly attached to a base of the gear rack and/or each other by welding, soldering, glue or/and mechanically.

3. The linear rack drive according to claim 1, wherein the toothed surfaces of the gear rack are formed by helical teeth.

4. The linear rack drive according to claim 1, wherein the toothed surfaces of the gear rack are formed by herringbone teeth.

5. The linear rack drive according to claim 1, wherein the toothed surfaces of the gear rack are formed by arched teeth.

6. The linear rack drive according to claim 2, wherein the toothed surfaces of the gear rack are formed by helical teeth.

7. The linear rack drive according to claim 2, wherein the toothed surfaces of the gear rack are formed by herringbone teeth.

8. The linear rack drive according to claim 2, wherein the toothed surfaces of the gear rack are formed by arched teeth.

9. The linear rack drive according to claim 1 wherein the polygon has the number from two to six sides.

10. A linear rack drive for a submersible rod pump for oil production, comprising
an electric drive unit,
a rack and pinion drive comprising
a gear rack,
a pinion gear mechanically connected to an output member of the electric drive unit,
a polished rod connection unit, wherein
a toothed surface of the gear rack is made up of several parts having a length shorter than a length of a whole toothed surface of the gear rack, said parts fixedly attached to a base of the gear rack and/or each other by welding, soldering, glue or/and mechanically.

11. The linear rack drive according to claim 10, wherein the toothed surface of the gear rack is formed by helical teeth.

12. The linear rack drive according to claim 10, wherein the toothed surface of the gear rack is formed by herringbone teeth.

13. The linear rack drive according to claim 10, wherein the toothed surface of the gear rack is formed by arched teeth.
